(19) United States
(12) Patent Application Publication
(10) Pub. No.: US 2004/0164002 A1
(43) Pub. Date: Aug. 26, 2004

(54) Method for sink and float separation of fine grained mineral raw materials

(76) Inventors: Heinrich Emil Jerzembski, Heerlen (NL); Jan Bot, Avenhorn (NL)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/473,514

(22) PCT Filed: Mar. 1, 2002
(86) PCT No.: PCT/IB02/02016

(30) Foreign Application Priority Data
Mar. 30, 2001 (DE) 101 16 027.5

(51) Int. Cl. B03B 5/64; B03B 5/60

(52) U.S. Cl. 209/162

(57) ABSTRACT

The invention relates to a device for the sink and float separation of mineral raw materials, particularly coal, according to density by means of a liquid, particularly a dense medium. The device comprises a separating container (1) with a cylinder (2) arranged in a rotatable manner therein for extracting the sunken items. The separating container comprises inlets (6; 10, 11) for the liquid and for the raw material which is to be separated, in addition to at least one outlet (12, 13) for the liquid, and one overflow (13) for separating the floating items. The inlets and outlets (10, 11; 12, 13) are arranged in a parallel position with respect to the axis of rotation of the cylinder (2). According to the invention, at least two respective inlets and outlets (10; 11; 12, 13) are provided for the liquid, being arranged, respectively, opposite each other in pairs on a specific height. At least one inlet and one outlet (10; 13) and the overflow (13) are arranged on the same levels as the liquid and at least one pair of inlets and outlets (11, 12) are disposed directly above the pockets of the sunken items (3) which are distributed over the periphery of the outer surface of the drum. The invention also relates to a corresponding method for the sink and float separation of mineral raw materials.

The invention relates to an apparatus according to the preamble of patent claim 1 and to a method according to the preamble of patent claim 14.

For the processing of mineral raw materials and their separation from undesirable accompanying constituents, for example for the separation of the debris constituents contained in raw coal and the clean coal, various separating methods are known which separate the various constituents of the raw material on the basis of their different specific weights, for example dynamic methods such as cylinders or cyclones, in which dense medium rotates and forms a vortex, or jigs, but also static methods with washing drums (sink-and-float separating apparatuses). For the processing of fine-grained mineral mixtures, in particular raw coal fractions as well, for example smaller than 12 mm, virtually only dynamic separating methods with cylinder or cyclone were suitable hitherto if a high separation grade was required, but said dynamic separating methods have the disadvantage of a low delivery and throughput capacity with high specific consumption of energy and pulp throughput. Although it was possible to achieve higher capacities with jigs and sink-and-float separation apparatuses, the separation grade to be achieved with these apparatuses and corresponding methods was inadequate.

This situation is explained by the table below, in which technical classification figures of some separating methods for coal are compared. In this case, the DWP cylinder represents cylinders and the DSM cyclone represents cyclones, and the washing drum represents a sink-and-float separating apparatus, the values specified applying to the processing of a grain fraction of 3 to 12 mm with cylinder and cyclone and of coarse coal with the washing drum. The values for the processing of the grain fraction of 3 to 12 mm with the washing drum would be considerably poorer. The characteristic figure according to Terra ET, which was determined from the partition curve according to Tromp, was selected as a measure of the separation grade. In this case, the ET values of 0.04 for cylinder and cyclone are nearer to theoretical target values which can scarcely be reached in practice.

| Method | | DWP cylinder | DSM cyclone | Washing drum |
|---|---|---|---|---|
| Grain size | | −3 to 12 mm- | | Coarse coal |
| Size | | Ø 400 mm | Ø 600 mm | Bath 1780 mm |
| Material | m³/h | 35 | 80 | 140 |
| delivery | | | | |
| E_{T} | | 0.04-0.07 | 0.04-0.07 | 0.09 |
| Pulp | m³/h | 170 | 450 | 220 |
| quantity | m³/t/h | 6.3 | 7.5 | 2.2 |
| Pumping | kW | 37.5 | 75 | 37.5 |
| capacity | | | | |

Apparatuses and methods described at the beginning have been disclosed by DE 11 93 892 and DE 33 27 040.

Apparatuses and methods described at the beginning have also been disclosed by DE 968 121, the apparatus additionally having a second inlet and outlet pair for the liquid below the liquid level. In the method described therein, the bottom liquid flow is so strong that it drives heavy material into the region of the scoop feeders, arranged laterally on the end face of the drum, for the sink-product/heavy-material discharge and acts as a transport flow for heavy material. In this case, float product adhering to the heavy material may be discharged with the sink product, as a result of which the yield drops.

The invention is based on the technical problem of developing an apparatus with which mineral raw materials, in particular coal of small-grained fractions, can be separated according to density from undesirable accompanying constituents and with which a high separation grade and capacity can be achieved with a low specific consumption of energy and throughput of operating media, and to propose a method with which this object can be achieved. This object is achieved by an apparatus having the features of patent claim 1 and by a method having the features of patent claim 14.

With the apparatus proposed, it is possible to build up a dense-medium bath with a steady, uniform flow from the inlet side of the separating vessel to the outlet or overflow side. In order to avoid disturbing effects on the uniform flow, the discharge drum is only rotated slowly. In particular, care is also to be taken to ensure that the same pulp quantities are fed and discharged at the bottom inlet and outlet so that the flow runs horizontally and no vertical flows are superimposed.

With the apparatus proposed, with values which were otherwise the same as with the conventional washing drum for coarse coal, it was possible to process a grain fraction of 3 to 12 mm with an E_{T} of 0.02 and thus a very good separation grade. It was even possible, although with half the feed quantity of 70 m³/h, to separate a coal grain fraction of 1 to 3 mm having a very clean end product, which indicates a high degree of separation.

The deflecting barriers proposed in a special embodiment cause the float product floating at the surface to plunge into the dense-medium bath, as a result of which the grains perform a movement relative to the dense medium and in the process are separated from sink-grain fractions possibly still adhering or from enclosed sink-grain fractions, so that one can subsequently float up again in separated form. The rear deflecting barrier in the direction of flow has the advantage that it divides the float-product layer and reduces the thickness of the float-product layer, as a result of which the heavy material is liberated from the surrounding float product and can sink unhindered. The course of the bottom edge of the deflecting barrier parallel to and just below the liquid level has the advantage that the dense-medium flow is deflected in a way that does not disturb the uniform and essentially laminar flow.

In a preferred embodiment, the plate of the rear deflecting barrier in the direction of flow has corrugations arranged parallel to one another, so that on the bottom of the corrugation profile only relatively small float-product layers form, which with their small surface size, influence and decelerate the flow to only a minimum extent. The corrugations may have both a rounded-off profile and a V-shaped profile. The height of the arrangement of the rear deflecting barrier is advantageously empirically set in such a way that a desired fraction of the float product is caught by the deflecting barrier and forced downward into the bath. An expedient control variable for the fraction to be caught is the separation grade of the separated material, which is expediently to be determined at the overflow.

In a special embodiment, the top inflow line for the dense medium extends over the entire bath width. An essential precondition for the formation of a uniform flow over the entire bath width is thus provided. This can be arranged in an especially advantageous manner if the inlet device permits the control of the flow profile over its width. This is possible, for example, by an inlet device which consists of a vessel extending over the bath width and having at least one inlet opening and, toward the separating vessel, a multiplicity of equispaced openings, the cross section of which can be specifically reduced from inside. This may be effected, for example, by screens which are arranged inside the vessel and can be operated from outside and with which the free cross sections of the individual outlet openings can be specifically covered, as a result of which the discharging liquid flow is reduced. With such an apparatus, discontinuities or disturbances of the flow which are observed during operation can be specifically countered.

In a further special embodiment, the apparatus, for the delivery of the raw material to be separated, has a chute which is inclined towards the separating vessel and which has a plate which is arranged on the base and consists of a profiled material corrugated in the longitudinal direction, the end of this chute being arranged at an adjustable distance above the liquid bath. The inclination of the chute and the arrangement of its end above the liquid bath causes the raw material to be delivered onto the liquid bath, at a speed adjustable by the inclination, and to plunge into said liquid bath. The corrugated design of the chute base leads to a reduction in the frictional resistance and thus in the braking effect of the base layer. The spraying of the feed material with water assists the discharge of the raw material from the chute and dilutes the dense medium in the region of the raw-material delivery, thereby favouring the heavy-material constituents to sink. It is also important that the first deflecting barrier is arranged in such a way that it lies downstream of the trajectory parabola of the feed material, so that the latter does not hit the deflecting barrier, a factor which would lead to a reduction in the feed rate and thus to a reduction in the depth to which the raw material plunges into the dense-medium bath.

The uniform distribution of a large number of sink-product pockets over the circumference of the drum shell causes the sink product to be correspondingly distributed over the various sink-product pockets and ensures that the pockets are not filled unevenly or to an excessive degree. The liquid-permeable design of the walls of the sink-product pockets, together with the small extent the pockets are filled with the sink product, ensures that no liquid is skimmed off when a sink-product pocket is lifted out of the liquid bath and that the liquid level is not greatly affected by the only slight displacement volume of the pocket contents.

The formation of two horizontal liquid flows has the advantage that the float product is conveyed to the overflow with the top liquid flow, and the sink product is caught by the flow at two different bath heights and is moved relative to the dense medium, whereby the separated heavy material can sink and adhering float product can be released and can float up. The extent to which the heavy material is caught by the flow is increased by the flow deflection. The delivery of the raw material at high speed to the liquid bath and the deep plunging of the sink-p product fractions caused thereby favours the separation of the heavy-material fractions from adhering float-product grains, which is also intensified by the spraying of the raw material with water and by the resulting dilution of the dense medium in the region of the raw-material delivery.

The advantages of the invention are explained in the description of an exemplary embodiment, which is shown in the attached drawing, in which:

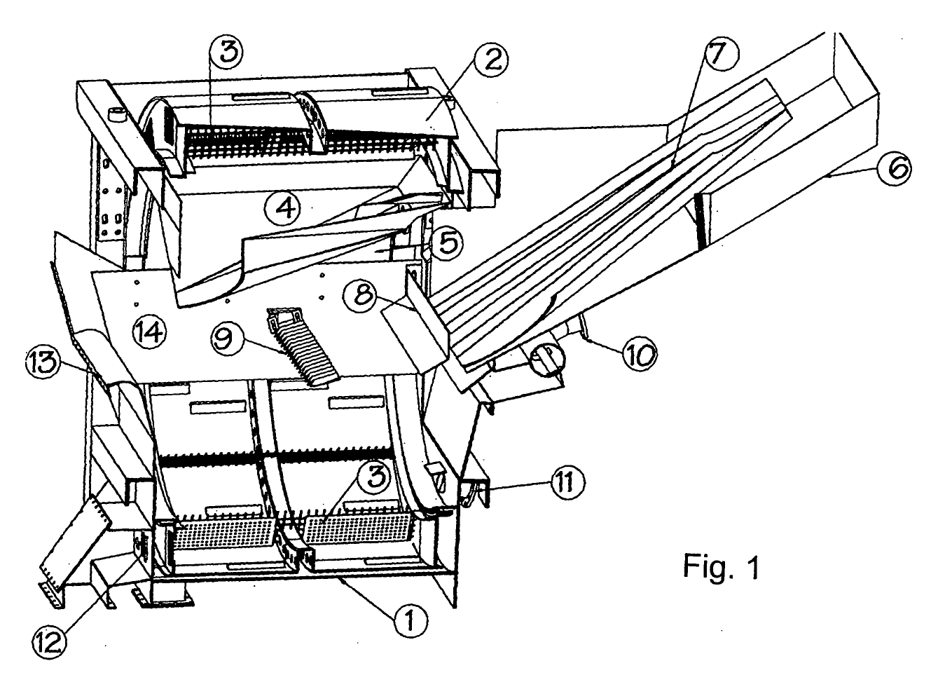

FIG. 1 shows a partly sectioned sink-and-float separating apparatus in perspective representation, and

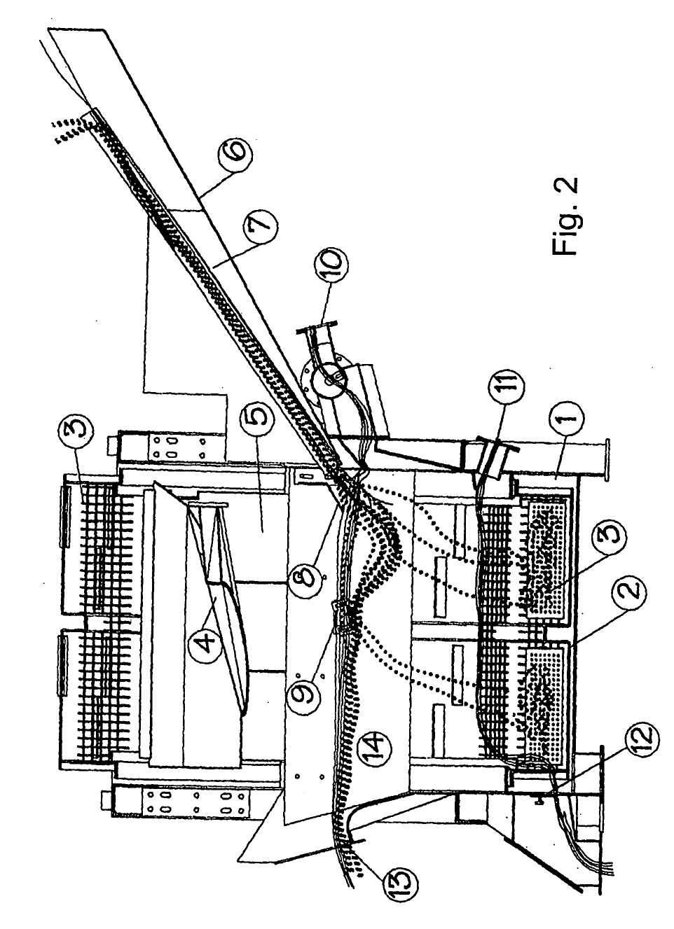

FIG. 2 shows the front view of a sectioned apparatus according to FIG. 1 during operation.

A partly sectioned sink-and-float separating apparatus is shown in perspective representation in FIG. 1. In the trough-shaped separating vessel 1, the drum 2 is rotatably arranged. The drum is driven by four vertically adjustable gears (not shown) by means of a centrally arranged pinion (likewise not shown) engaging in the toothed rim. The sink-product pockets 3 distributed over the inner circumference of the drum shell can be clearly seen, their walls being designed to be permeable to liquid. When the sink-product pockets are rotated into a top position, the sink product discharged into the sink-product pockets falls downward by gravitational force into a sink-product chute 4, by means of which the sink product is brought out of the separating vessel. In order to prevent the sink product from falling back onto the pulp bath or onto the float product floating thereon, cover plates 5 are arranged in the top area. The raw material to be separated is delivered via the delivery chute 6, which has a corrugated base 7. The front deflecting barrier 8, which in the exemplary embodiment shown has the form of an angled plate, and the rear deflecting barrier 9, which consists of a corrugated plate arranged transversely to the direction of flow and, like the front deflecting barrier, extends over the entire bath width, can readily be seen. The top pulp inlet 10 and the overflow weir 13 arranged opposite at the same height can clearly be seen. The bottom pulp inlet 11 and, opposite it, the outlet opening 12 of the bottom pulp outlet can clearly be seen just above the sink-product pockets 3. The pulp-bath boundary plate 14, to which the one end of the rear deflecting barrier 9 is fastened, is shown in the top rear region.

The front view of a sectioned apparatus during operation is shown in FIG. 2. Via the delivery chute 6 having the corrugated base 7, the raw material is delivered from the right at high speed by the inclination of the chute 6, if possible without retardation, onto the dense-medium bath in such a way that it plunges into the bath. Approximately at the height of the pulp bath, fresh pulp is fed on the right-hand side via the top pulp inlet 10, whereas arranged opposite it at the same height is the overflow weir 13, via which the horizontal flow of float product is discharged, with corresponding pulp quantities also flowing off. While the sink-product fraction sinks down through the pulp bath, the float product is conveyed to the overflow weir by the horizontal dense-medium flow. The pulp flow is deflected by the front deflecting barrier plunging into the pulp bath and by the rear deflecting barrier 9 arranged approximately in the center between inlet 10 and overflow weir 13. The float-product fractions floating at the top are forced downward into the bath by the deflection of the pulp flow, as a result of which the separation of sink-product fractions from adhering float-product fractions is intensified and the separating effect is favorably influenced overall. The sinking heavy material falls into the sink-product pockets 3 distributed over the circumference and is conveyed upward by the rotation of the drum and discharged. After appropriate rotation of the drum, the sink product falls onto the sink-product chute 4, via which the sink product is discharged from the separating apparatus.

The bottom pulp inlet 11 and the outlet opening, arranged opposite it at the same height, of the bottom pulp outlet 12 can readily be seen in this representation. The sinking heavy material is caught by the horizontal pulp flow formed between the pulp inlet and the pulp outlet and is moved once again relative to the dense medium, which promotes further separation of the sink-product fractions from adhering float-product fractions. After this second separating stage, the float product rises again in order to be combined with the top pulp flow and discharged toward the overflow weir 13. The cover plates 5 arranged in the top rear region and the pulp-bath boundary plates 14 can also be clearly seen.

List of Designations

1 Separating vessel (trough)

2 Drum

3 Sink-product pockets

4 Sink-product chute

5 Cover plates

6 Delivery chute

7 Corrugated base

8 Front deflecting barrier

9 Rear deflecting barrier

10 Top pulp inlet

11 Bottom pulp inlet

12 Outlet opening of bottom pulp outlet

13 Overflow weir

14 Pulp-bath boundary plates

1. An apparatus for the sink-and-float separation of mineral raw materials, in particular coal, according to density by means of a liquid, in particular a dense medium, consisting of a separating vessel (1) having a drum (2) rotatably arranged therein for the discharge of the sink product, the separating vessel having inlets (6, 10, 11) for the liquid and the raw material to be separated and at least one outlet (12, 13) for the liquid and an overflow (13) for separating the float product, wherein the inlets and outlets (10, 11; 12, 13) are arranged parallel to the axis of rotation of the drum (2), and at least two outlets and inlets (10, 11; 12; 13) are provided in each case for the liquid and are arranged in each case opposite one another in pairs at one height, wherein at least one inlet and one outlet (10; 13) and the overflow (13) are arranged at the height of the liquid level, and at least one inlet and outlet pair (11, 12) are arranged just above sink-product pockets (3) distributed over the circumference of the drum shell,
characterized in that at least two deflecting barriers (8, 9) projecting into the liquid from above and arranged over the entire width transversely to the direction of flow are provided, of which deflecting barriers (8, 9) at least one is arranged just behind the point at which the raw material to be separated is delivered into the liquid and at least one is arranged approximately in the center between inlet and outlet for the liquid in such a way that the rear deflecting barrier in the direction of flow divides the float-product layer.

2. The apparatus as claimed in claim 1, characterized in that the first barrier (8) in the direction of flow is arranged in such a way that it lies downstream of the trajectory parabola of the feed material.

3. The apparatus as claimed in claim 2, characterized in that the deflecting barrier (8) consists of a plate which is angled transversely to the direction of flow and whose bottom leg is directed obliquely downward in the direction of flow and whose bottom edge is arranged parallel to and just below the liquid level.

4. The apparatus as claimed in claim 1, characterized in that the deflecting barrier (9) arranged approximately centrally between inlet and outlet consists of a corrugated plate, the corrugations of which lie parallel to one another in the direction of flow, the plate being arranged obliquely in such a way that its leading edge lies approximately at the height of and parallel to the liquid level and its trailing edge lies below the leading edge.

5. The apparatus as claimed in claim 4, characterized in that the corrugations have a rounded-off profile.

6. The apparatus as claimed in claim 4, characterized in that the corrugations have a V-shaped profile.

7. The apparatus as claimed in at least one of the claims 1 to 6, characterized in that the top inlet device (10) for the liquid extends over the entire bath width.

8. The apparatus as claimed in claim 7, characterized in that the inlet device (10) permits the control of the flow profile over its width.

9. The apparatus as claimed in claim 8, characterized in that the inlet device (10) is a vessel extending over the bath width and having at least one inlet opening and, toward the separating vessel (1), a multiplicity of equispaced outlet openings, the cross section of which can be specifically reduced from inside.

10. The apparatus as claimed in at least one of the claims 1 to 9, characterized in that, for the delivery of the raw material to be separated, it has a chute (6) which is inclined toward the separating vessel (1) and whose base (7) has a profile corrugated in the longitudinal direction and ends at an adjustable distance above the liquid bath.

11. The apparatus as claimed in claim 10, characterized in that a device for spraying the feed material with water in the direction of the separating vessel (1) is arranged above the delivery chute (6).

12. The apparatus as claimed in at least one of the claims 1 to 11, characterized in that a large number of sink-product pockets (3) are distributed uniformly over the circumference.

13. The apparatus as claimed in claim 12, characterized in that the walls of the sink-product pockets (3) are designed to be permeable to the liquid.

14. A method for the sink-and-float separation of mineral raw materials, in particular coal, according to density by means of a liquid, in particular a dense medium, in which liquid is fed via inlets into a separating vessel having a drum rotatably arranged therein and is discharged via outlets, arranged at the opposite side at the same height, in such a way that in the separating vessel a liquid bath builds up, the level of which lying approximately at the height of the axis of rotation of the drum, and a horizontal flow parallel to the axis of rotation of the drum from the inlet to the associated outlet results inside the liquid bath, the feed material to be separated being delivered parallel to the liquid in such a way that it plunges into the liquid bath and is caught by the liquid flow, the float product on the side opposite the feed being separated by means of an overflow, and the sink product sinking through the liquid bath, characterized in that at least two horizontal uniform and essentially laminar liquid flows are formed which only transport float product to the discharge side and of which at least one lies directly at and below the liquid level and at least one lies just above sink-product pockets (3) distributed over the circumference of the drum shell.

15. The method as claimed in claim 14, characterized in that the flow at the liquid level is deflected by at least two barriers (8, 9) which are arranged transversely to the direction of flow and which project into the liquid bath from above, at least one being arranged directly downstream of the inlet and at least one being arranged approximately centrally between inlet and associated outlet.

16. The method as claimed in claim 14 or 15, characterized in that the top liquid flow is uniformly regulated over the entire bath width.

17. The method according to at least one of the claims 14 to 16, characterized in that the raw material is delivered to the liquid bath at high speed.

18. The method according to at least one of claims 14-17, characterized in that the bottom uniform and essentially laminar flow moves the sink product relative to the dense medium and releases float-product fractions adhering to the sink product, so that these float-product fractions can rise into the region of the top liquid flow in order to be discharged with the rest of the float product.

19. The method as claimed in at least one of claims 16 to 18, characterized in that the float-product layer is divided by the rear deflecting barrier and reduced in its thickness.

20. The method as claimed in at least one of claims 15 to 19, characterized in that the rear deflection of the liquid flow is effected in such a way that a predeterminable fraction of the material floating at the surface is caught and forced into the liquid.

21. The method as claimed in at least one of claims 17 to 20, characterized in that the raw material is sprayed with water and water-jetted
